(19) United States
(12) Patent Application Publication
(10) Pub. No.: US 2008/0227679 A1
(43) Pub. Date: Sep. 18, 2008

(54) Biodegradable Cleaning Compositions

(75) Inventors: Eddy Mangnus, Deventer (NL); Alart Mulder, Deventer (NL); Arno Schut, Nijverdal (NL); Leonique Sonnemans, Zenderen (NL); Miryam Ter Harmsel, Rijssen (NL)

Correspondence Address: MORGAN, LEWIS & BOCKIUS LLP, 1701 MARKET STREET, PHILADELPHIA, PA, 19103-2921, US

(73) Assignee: Elementis Specialties, Inc., Hightstown, NJ (US)

(21) Appl. No.: 12/047,928

(22) Filed: Mar. 13, 2008

Related U.S. Application Data
(60) Provisional application No. 60/906,686, filed on Mar. 13, 2007.

(51) Int. Cl. C11D 1/62

(52) U.S. Cl. 510/238; 510/501; 510/495; 510/488; 510/365; 510/278; 510/240; 510/245

(57) ABSTRACT

The present invention is related to readily biodegradable cleaning compositions, methods of use, and manufacture thereof. The cleaning composition comprises a non-ionic surfactant and an amidoalkyl quaternary salt.

### RELATED APPLICATIONS

This application claims the benefit of U.S. Provisional Application No. 60/906,686, filed Mar. 13, 2007, entitled “Biodegradable Cleaning Compositions” which is incorporated by reference herein in its entirety.

### FIELD OF THE INVENTION

The present invention relates to readily biodegradable, pH stable general purpose cleaners for, e.g., efficiently removing both food and industrial grease, road dirt, heel marks, and the like from hard surfaces and further uses such as removing food soils, grease, and the like from fibrous substrates such as carpet, furniture, and similar substrates. The present invention is also directed to a readily biodegradable cleaning composition comprising an amidoalkyl quaternary ammonium salt.

### BACKGROUND

Cleaning compositions are widely used. Because of the toxicity problems and environmental hazards due to the chemicals in many cleaning compositions the European Union has instituted regulations requiring that cleaning compositions be readily biodegradable. There are many publications that describe various cleaning compositions (see, e.g. WO 03/03159 and U.S. Pat. No. 6,849,589, each of which is hereby incorporated by reference in its entirety). However, these compounds and formulations have several disadvantages and limitations. The formulations of the prior art are, in general, not readily biodegradable. On the contrary, a considerable number of the quaternary ammonium salts used to formulate these cleaners are known biocides. More recently, cleaners based on so-called ester quats, quaternary ammonium salts prepared from fatty esters of ethanolamines, have been developed. Some of these quaternary ammonium compounds are readily biodegradable, but the ester linkages are hydrolytically unstable in the pH ranges at which these cleaners are formulated; therefore the formulations are not stable, and lose efficiency, or worse, on aging. Accordingly, there is a need to develop readily biodegradable cleaning compositions that are stable and maintain their efficiency and effectiveness on aging. The present invention fulfills this need as well as others.

### SUMMARY OF THE INVENTION

In some embodiments, the present invention provides readily biodegradable cleaning compositions comprising an amidoalkyl quaternary salt and a non-ionic surfactant, wherein the amidoalkyl quaternary salt has formula (1) or (2)

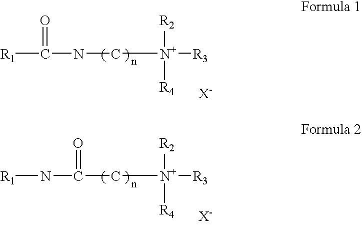

wherein R₁ includes a straight or branched chain alkyl, or straight or branched chain heteroalkyl, comprising from 8 to 20 carbon atoms; n ranges from 1 to 6; R₂, R₃, and R₄ are independently selected from the group consisting of hydrogen, straight or branched chain alkyl or heteroalkyl radicals, said chains comprising 1 to 7 atoms, or polyalkoxy chain comprising from 1 to 15 alkoxy units per chain, wherein said chains are optionally substituted; and X⁻, wherein X⁻ optionally includes a monovalent anion; or wherein said amidoalkyl quaternary salt has formula (3) or (4)

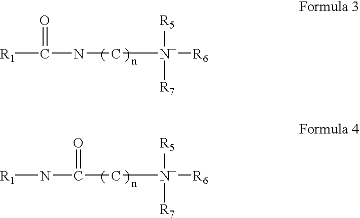

wherein R₁ includes a straight or branched chain alkyl, or straight or branched chain heteroalkyl, comprising from 8 to 20 carbon atoms; n ranges from 1 to 6; wherein at least one of R₅, R₆ and R₇ includes a radical substituted with a carboxylic, sulfonic, phosphinic or phosphonic moiety, and the remainder are independently selected from the group consisting of hydrogen, straight or branched chain alkyl or heteroalkyl radicals, said chains comprising 1 to 7 atoms, or polyalkoxy chain comprises 1 to 15 alkoxy units per chain, wherein said chains are optionally substituted.

In some embodiments, the present invention provides methods of cleaning a surface comprising contacting the surface with a readily biodegradable cleaning composition as described herein.

In some embodiments, the present invention provides processes for the preparation of the compositions described herein mixing the non-ionic surfactant with the amidoalkyl quaternary salt of Formula (1), Formula (2), Formula (3), or Formula (4).

In some embodiments, the present invention provides processes for the preparation of the composition described herein comprising preparing the amidoalkyl quaternary ammonium salt in the presence of the nonionic surfactant.

### Description of the Embodiments

In accordance with the present invention, improved readily biodegradable general purpose cleaning compositions are described that are efficient in removing food and industrial grease, heel marks, dirt, oils, traffic film, animal and vegetable residues, and the like from hard surfaces such as tiles, (coated) metallic substances, (coated) wood, plastics and glass. Further, the compositions may have other uses such as removing food soils, grease, and the like from fibrous substrates such as carpet, furniture, and similar substrates. It has been discovered that certain mixtures of nonionic surfactants and quaternary amine salts have several advantages including the property of being readily biodegradable, which may include being readily biodegradable according to the OECD 301 guidelines for testing the ready biodegradability of chemicals, therewith fulfilling the criteria for European detergent regulations. The OECD Guidelines for the Testing of Chemicals are a collection of relevant internationally agreed testing methods used by government, industry and independent laboratories to characterize potential hazards of new and existing chemical substances and chemical preparations/mixtures.

The compositions are also hydrolytically stable at the pHs and temperatures at which such compositions are formulated and used. These cleaning compositions may be further improved by combining with a slightly water-soluble polar organic compound.

A composition for removing hydrocarbon-containing soils in accordance with the present invention comprises a nonionic surfactant and an amidoalkyl quaternary amine salt, and, optionally, a very slightly water-soluble polar organic compound, and water. The composition may also contain other optional but conventional additives.

In some embodiments, the readily biodegradable cleaning compositions are based on a composition comprising an amidoalkyl quaternary salt and a non-ionic surfactant. The amidoalkyl quaternary salt has formula (1) or (2).

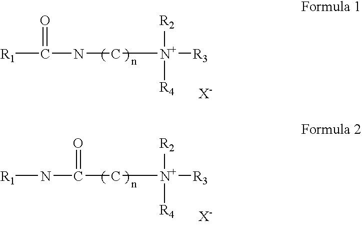

In one embodiment, where the salt has formulas (1) and (2), R₁ may be a straight or branched chain alkyl radical, or straight or branched chain heteroalkyl radical, including from 8 to 20 carbon atoms. In one such embodiment, the hetero atom of the R₁ heteroalkyl radical includes any hetero atom other than carbon and hydrogen. In another such embodiment, the hetero atom of the R₁ heteroalkyl radical includes an oxygen atom, a nitrogen atom, a sulfur atom, or a phosphorus atom. In still another such embodiment, the hetero atom of the R₁ heteroalkyl radical includes an oxygen atom, a nitrogen atom, or a sulfur atom. In one embodiment, n is an integer ranging from 1 to 6. In another embodiment, R₂, R₃, and R₄ are independent from one another and may be hydrogen, straight or branched chain alkyl radical or heteroalkyl radical wherein the alkyl chain and the heteroalkyl radical include from 1 to 7 carbon atoms or polyalkoxy chain having 1 to 15 alkoxy units per chain. In one such embodiment, the hetero atom of the R₂, R₃, or R₄ heteroalkyl radical includes any hetero atom other than carbon and hydrogen. In another such embodiment, the hetero atom of the R₂, R₃, or R₄ heteroalkyl radical includes an oxygen atom, a nitrogen atom, a sulfur atom, or a phosphorus atom. In still another such embodiment, the hetero atom of the R₂, R₃, and R₄ heteroalkyl radical includes an oxygen atom, a nitrogen atom, or a sulfur atom. In another embodiment, any of the above alkyl, heteroalkyl or polyalkoxy chains are optionally substituted and/or unsaturated.

In another embodiment, where the salt has formulas (1) and (2), R₁ may be a straight or branched chain alkyl radical. In one such embodiment, the alkyl radical has from 8 to 13 carbon atoms. In another such embodiment, the alkyl radical has from 11 to 13 carbon atoms. In still another such embodiment, the alkyl radical has from 8 to 9 carbon atoms. In another embodiment, R₂, R₃, and R₄ are independent from one another and may be a straight or branched chain alkyl radical or heteroalkyl radical wherein the alkyl chain and heteroalkyl radical include from 1 to 4 carbon atoms. In one embodiment, n is an integer ranging from 1 to 6. In one example, n is 1, 2, 3, 4, 5, or 6.

In another embodiment, the amidoalkyl quaternary salt of formula (1) or (2) includes X⁻, wherein X⁻ is optionally a monovalent anion. In one such embodiment, the amount of total anionic charge is equal to the total cationic charge such that electrical neutrality is achieved. In still another embodiment, the monovalent anion includes chloride, bromide, methylsulfate, ethylsulfate, acetate, and the like.

In another embodiment, the amidoalkyl quaternary salt may also have formula (3) or (4).

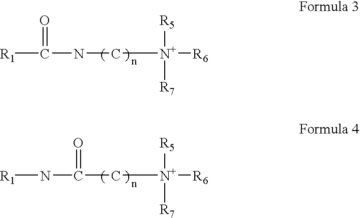

In still another embodiment, where the salt has formula (3) or (4), R₁ may be a straight or branched chain alkyl radical, or straight or branched chain heteroalkyl radical, having from 8 to 20 carbon atoms. In one such embodiment, the hetero atom of the R₁ heteroalkyl radical includes any hetero atom other than carbon and hydrogen. In another such embodiment, the hetero atom of the R₁ heteroalkyl radical includes an oxygen atom, a nitrogen atom, a sulfur atom, or a phosphorus atom. In still another such embodiment, the hetero atom of the R₁ heteroalkyl radical includes an oxygen atom, a nitrogen atom, or a sulfur atom. In one embodiment, n is an integer ranging from 1 to 6. In one embodiment, at least one of R₅, R₆ and R₇ includes a radical substituted with a carboxylic, sulfonic, phosphinic or phosphonic moiety, and the remainder are independently selected from the group consisting of hydrogen, straight or branched chain alkyl radical or heteroalkyl radical said alkyl chains having from 1 to 7 atoms, or polyalkoxy chain having from 1 to 15 alkoxy units per chain. In one such embodiment, the hetero atom of the R₅, R₆ or R₇ heteroalkyl radical includes any hetero atom other than carbon and hydrogen. In another embodiment, the hetero atom of the R₅, R₆ or R₇ heteroalkyl radical includes an oxygen atom, a nitrogen atom, a sulfur atom, or a phosphorus atom. In a further embodiment, the hetero atom of the R₅, R₆ or R₇ heteroalkyl radical includes an oxygen atom, a nitrogen atom, or a sulfur atom. In one embodiment, any of the above alkyl, heteroalkyl or polyalkoxy chains are optionally substituted and/or unsaturated.

In one embodiment, for formulas (3) and (4), R₁ includes from 8 to 12 carbon atoms and n is an integer ranging from 1 to 6. In one example, n is 1, 2, 3, 4, 5, or 6. In one embodiment, one of R₅, R₆ and R₇ includes a radical substituted with a carboxylic moiety, and the remainder are independently selected from the group consisting of straight or branched chain alkyl radical or heteroalkyl radical said alkyl chains having from 1 to 4 atoms.

In another embodiment, the optionally substituted chains, of formulas (1), (2), (3) and/or (4) have substituents that can include an alkoxy group (R—O—), acyloxy groups (R—C(═O)—O—), hydroxyl moieties (HO—), a halide at any point along the chain. In yet another embodiment, the optionally substituted chains include a polyalkoxy chain having 2 to 6 carbons per alkoxy unit. In still yet another embodiment, the polyalkoxy chain includes 1 to 15 alkoxy units per chain. In another embodiment, the polyalkoxy chain includes 1 to 4 alkoxy units per chain. In another embodiment, the polyalkoxy chain includes 1 alkoxy unit per chain.

In some embodiments, the amidoalkyl quaternary salts having formula (3) or (4) form an internal salt.

In some embodiments, the quaternary salt has the formula of: Formula 5 (Ethoxylated amide of coco fatty acid and aminoethylethanolamine, quaternized with dimethyl sulfate (DMS)); Formula 6 (Amide of capric acid and dimethylaminopropylamine, quaternized with DMS); Formula 7 (Amide of coco fatty acid and dimethylaminopropylamine, HCl salt, quaternized with 1 mol of ethylene oxide (EO)); Formula 8 (Amide of coco fatty acid and dimethylaminopropylamine, quaternized with DMS); Formula 9 (Amide of capric acid and dimethylaminopropylamine, quaternized with chloroacetic acid (sodium salt)); or Formula 10 (Amide of coco fatty amine and N,N-dimethylglycine, quaternized with DMS).

The structures of Formulas 5-10 are as follows:

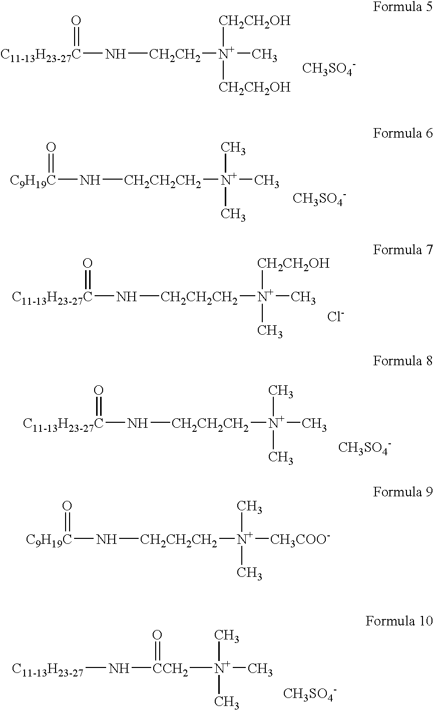

The non-ionic surfactant can be any non-ionic surfactant suitable for a readily biodegradable cleaning composition. Examples of non-ionic surfactants suitable for a readily biodegradable cleaning composition include nonionic surfactants formed by condensation of alkyl phenols, alkyl amines, alkyl amides, alkyl acids, or aliphatic alcohols with sufficient ethylene oxide, propylene oxide, or a combination thereof, to produce a compound having a polyoxyethylene and/or polyoxypropylene chain within the molecule, or a random or block copolymer thereof. In one embodiment, the nonionic surfactant is formed by condensation of an alkyl amine and ethylene oxide to produce a compound having a polyoxyethylene chain within the molecule. In one such embodiment, the amount of ethylene oxide ranges from 5 moles to 40 moles of ethylene oxide per mole of alkyl amine. In another such embodiment, the amount of ethylene oxide ranges from 5 moles to 15 moles of ethylene oxide per mole of alkyl amine. In yet another such embodiment, the alkyl radical of the alkyl amine has from 8 to 14 carbon atoms.

In another embodiment, the nonionic surfactant is formed by condensation of an alkyl amide and ethylene oxide to produce a compound having a polyoxyethylene chain within the molecule. In one such embodiment, the amount of ethylene oxide ranges from 5 moles to 40 moles of ethylene oxide per mole of alkyl amine. In another such embodiment, the amount of ethylene oxide ranges from 5 moles to 15 moles of ethylene oxide per mole of alkyl amine. In yet another such embodiment, the alkyl radical of the alkyl amide has from 8 to 14 carbon atoms.

In still another embodiment, the nonionic surfactant is formed by condensation of an aliphatic alcohol and ethylene oxide to produce a compound having a polyoxyethylene chain within the molecule. In one such embodiment, the amount of ethylene oxide ranges from 5 moles to 40 moles of ethylene oxide per mole of aliphatic alcohol. In another such embodiment, the amount of ethylene oxide ranges from 5 moles to 15 moles of ethylene oxide per mole of aliphatic alcohol. In yet another such embodiment, the aliphatic radical of the aliphatic alcohol has from 8 to 14 carbon atoms.

In some embodiments, the non-ionic surfactant may be a branched or linear primary alcohol ethoxylate, a secondary alcohol ethoxylate, a branched decyl/tridecyl alcohol ethoxylate, branched or linear, saturated or unsaturated fatty acid ethoxylates, a branched or linear alkylphenol ethoxylate, a branched or linear alkyl amine ethoxylate, a branched or linear alkyl amide ethoxylate, an alkyl ether amine ethoxylate, a linear alcohol alkoxylate, and alkyl glucosides, and the like, and a mixture thereof. The non-ionic surfactant includes ethoxylated acids such as polyethoxylated lauric and polyethoxylated stearic acid.

In some embodiments, the non-ionic surfactant may be a branched or linear primary alcohol ethoxylate, a branched or linear alkyl amine ethoxylate, or a branched or linear alkyl amide ethoxylate. In one embodiment, the non-ionic surfactant includes a branched or linear primary alcohol ethoxylate wherein the alcohol has from 8 to 14 carbon atoms. In one such embodiment, the amount of ethylene oxide ranges from 5 moles to 40 moles of ethylene oxide per mole of alcohol. In another such embodiment, the amount of ethylene oxide ranges from 5 moles to 15 moles of ethylene oxide per mole of alcohol. In another embodiment, the non-ionic surfactant may be a branched or linear alkyl amine ethoxylate, wherein the alkyl amine radical has from 8 to 14 carbon atoms. In one such embodiment, the amount of ethylene oxide ranges from 5 moles to 40 moles of ethylene oxide per mole of alkyl amine. In another such embodiment, the amount of ethylene oxide ranges from 5 moles to 15 moles of ethylene oxide per mole of alkyl amine. In still another embodiment, the non-ionic surfactant may be a branched or linear alkyl amide ethoxylate, wherein the alkyl amide radical has from 8 to 14 carbon atoms. In one such embodiment, the amount of ethylene oxide ranges from 5 moles to 40 moles of ethylene oxide per mole of alkyl amide. In another such embodiment, the amount of ethylene oxide ranges from 5 moles to 15 moles of ethylene oxide per mole of alkyl amide.

In some further embodiments, the non-ionic surfactant may be a branched or linear primary alcohol ethoxylate/propoxylate, a secondary alcohol ethoxylate/propoxylate, a branched decyl/tridecyl alcohol ethoxylate/propoxylate, branched or linear, saturated or unsaturated fatty acid ethoxylate/propoxylate, a branched or linear alkylphenol ethoxylate/propoxylate, a branched or linear alkyl amine ethoxylate/propoxylate, an alkyl ether amine ethoxylate/propoxylate, a linear alcohol ethoxylate/propoxylate, and mixtures thereof, including mixtures with the alkoxylates described in the preceding paragraph. It is to be understood that these ethoxylated/propoxylated derivatives may be either random or block copolymers, and that the oxyethylene and oxypropylene units may be in any order.

In some embodiments, the non-ionic surfactants have an HLB value of 7 to 16. “HLB,” as used herein, refers to an emulsification behavior of a surfactant as well as the relationship between hydrophilic and lipophilic portions of a molecule.

In still another embodiment, the non-ionic surfactants are commercially available and used for their detergent, surface active, wetting and emulsifying properties. As discussed above, a non-ionic surfactant used in the invention contains sufficient ethylene oxide units to insure solubility of the nonionic surfactant in the composition or in any dilution thereof that may be used in practice. In some embodiments, the non-ionic surfactants include from 5 moles to 40 moles of ethylene oxide per mole of nonionic surfactant, and in some embodiments 5 moles to 15 moles of ethylene oxide per mole of nonionic surfactant. Further suitable nonionic surfactants include “SERVO NRL 6,” “SERVO NRL 9,” “SERVO NBSQ 5/5,” “SERVO NCA 12,” “SERVO NCA 15,” “SERDOX NBS 6.6/90,” all of which are commercially available from Elementis Specialties, and alkyl glucosides such as “GLUCOPON 425,” available from Cognis Corporation. In one embodiment the non-ionic surfactant may be an alcohol ethoxylate wherein the alcohol has from 9 to 11 carbon atoms and 5-7 moles of ethylene oxide per mole of alcohol. In another embodiment, the non-ionic surfactant may be an alkyl amide wherein the alkyl radical has from 12 to 14 carbon atoms.

In some embodiments, other surfactants or detergent improvers can be used. Examples include those listed in the Examples section. In some embodiments, the formulations used in the present invention have a good to very good hydrotropic efficiency. In some embodiments, the formulations used in the present invention show very good to excellent degreasing properties. The formulations used in the present invention do generally show good to excellent wetting behavior and show low surface tensions already at low dosage. In some embodiments, the formulations show an excellent rinse-off effect.

In some embodiments, the weight percent of the nonionic surfactant typically ranges from 0.01 to 3.0 weight percent in ready-to-use formulations, with amounts of the surfactant greater than 3.0 weight percent being uneconomical and not typically rendering a more beneficial wetting property. In other embodiments, the weight percent of the nonionic surfactant typically ranges from 0.01 to 1.0 weight percent in ready-to-use formulations. If the amount of nonionic surfactant is below 0.01 weight percent, insufficient wetting of the hydrocarbon-containing soil-covered surface may be noticed, but this is not necessarily considered outside of the invention.

In some embodiments, in compositions in accordance with the present invention, the weight ratio of nonionic surfactant to quaternary amine typically ranges from 1:4 to 4:1. In some instances, the weight ratio of nonionic surfactant to quaternary amine ranges from 1:2 to 2:1. In other instances, the weight ratio of nonionic surfactant to quaternary amine preferably is 1:1. The compositions of the invention can, of course, be made, sold, and used as concentrates, or in diluted or “ready-to-use” form. When in “ready-to-use” form, the compositions may have the same ratios of actives as the concentrates. Actual effective dilution of the concentrates will depend on the intended surface to be cleaned, type of soil, degree of soiling, and the like. The concentration of the amidoalkyl quaternary ammonium salt/nonionic surfactant mixture in a concentrate of the readily biodegradable cleaner may be up to 100 weight %, up to 50 weight %, up to 10 weight %, or up to 4 weight % of the total formulation. The concentration of the amidoalkyl quaternary ammonium salt/nonionic surfactant mixture in a ready-to-use formulation of the readily biodegradable cleaner may be up to 15 weight %, up to 10 weight %, or up to 4 weight % of the total formulation.

As used herein, the term “weight percent” unless otherwise specified refers to (component weight/total weight)*100.

In one embodiment, the pH (i.e., negative logarithm of the hydrogen ion concentration) is greater than 7.0. In another embodiment, the pH is less than 5.0. In yet another embodiment, the pH is in the range of 5.0 to 8.0. In some instances, the pH is 4.5 to 8.5. In some embodiments, such as for solubilizing grease, the compositions of the invention are more effective at a pH greater than 7.0. However, the compositions of the invention can also be used at a pH lower than 7 (i.e., in acidic cleaning). The adjustment of pH may be achieved using chemicals such as low molecular weight alkanol amine compounds (e.g. 2-amino-2-methyl-1-propanol, monoethanolamine), ammonia, sodium hydroxide, hydrogen chloride and the like.

The compositions of the invention may include conventional additives such as a (slightly) water soluble polar organic compound. Preferably, the (slightly) water soluble polar organic compound is not a hydrocarbon or halocarbon, contains one or more heteroatoms from oxygen, nitrogen, sulfur, and/or phosphorous containing functional groups and contains an alkyl group containing 3 carbon atoms to 16 carbon atoms. More preferably, the slightly water soluble polar organic compound contains a moiety selected from the group of an alcohol, an aldehyde, a ketone, an ether, a glycol ether, an acid, an amine, an ester, a pyrrolidone, or a compatible mixture thereof.

The readily biodegradable cleaning composition can also comprise additional components, such as one or more of each of: thickening agents; colorants; fragrances; preservatives; anti-microbial agents; bacteriostats; additional surfactants; chelating agents; antioxidants; foaming or anti-foaming agents; film-forming agents; or combinations thereof. Examples of such components are readily known to one skilled in the art.

Further, it may be advantageous to include a compatible thickening agent to render the viscosity of the compositions of the invention such that they may be applied to a vertical surface, e.g., a baseboard, and not run therefrom. If such running occurs, the residence time of the composition with respect to the surface being cleaned would be reduced. Additionally, the composition may run onto areas where it is not wanted.

The present invention also provides methods of cleaning a surface comprising contacting said surface with the readily biodegradable composition described herein. In one application, the surface is substantially cleaned of food, industrial grease, heel marks, dirt, oils, traffic film, animal and vegetable residues, or combinations thereof, using the readily biodegradable composition described herein.

The compositions of the invention may be sprayed upon the soiled surface or simply poured thereon in concentrated or “ready-to-use” form as desired. Spraying may be accomplished by conventional mechanical spraying devices (such as by use of a conventional trigger spray device) or by using an aerosol-dispensing container with a sufficient amount of suitable aerosol propellant such as a low boiling alkanes or mixtures thereof, such as a mixture isobutane and propane. Performing a mechanical operation to the soiled surface after application of a composition of the invention may be desired or required for removing hydrocarbon-containing soils. Performing a mechanical operation may include wiping, abrading, scrubbing, brushing, and the like. If the underlying surface is soft and/or decorative, abrading or scrubbing may not be desirable.

The surface cleaned can be any surface. Examples of such surfaces include a fibrous substrate, a hard surface, and the like. Examples of a fibrous substrate include, but are not limited to carpet or furniture. The hard surface can be any hard surface. Examples of a hard surface include tile (e.g. ceramic, marble, granite, and the like), (coated) wood, (coated) cement, (coated) metallic substances, plastics, or glass.

The composition can be prepared by any method that allows the non-ionic surfactant and the amidoalkyl quaternary salt to come into contact with one another. The present invention provides processes for the preparation of the composition comprising mixing the non-ionic surfactant and amidoalkyl quaternary salt of Formula (1), Formula (2), Formula (3), or Formula (4). The present invention also provides processes for the preparation of the readily biodegradable composition comprising preparing the amidoalkyl quaternary ammonium salt in the presence of the nonionic surfactant.

Compositions described herein comply with Regulation (EC) No 648/2004 of The European Parliament and of The Council of 31 Mar. 2004 on detergents and, therefore, are readily biodegradable.

The term “readily biodegradable cleaning composition” refers to a composition that is readily biodegradable in an aerobic aqueous medium. For example, one can determine whether a composition is readily biodegradable by performing one of the following, non-limiting methods: DOC Die-Away; CO2 Evolution (Modified Sturm Test); MITI (I); Closed Bottle; Modified OECD Screening; or Manometric Respirometry. These methods are described in “OECD Guidelines for the Testing of Chemicals” Vol. 2, Section 3 (Adopted Jul. 17, 1992), hereby incorporated by reference in its entirety). Any of these methods, if conducted under GLP conditions, can be used to comply with Regulation (EC) No 648/2004 of The European Parliament and of The Council of 31 Mar. 2004 on detergents.

To determine the readily biodegradability of a composition, the composition may be tested using one or more of the tests described under OECD 301. In one embodiment, readily biodegradability is determined by a respirometry method, such as OECD 301B, OECD 301C, OECD 301D or OECD 301F, having pass levels for ready biodegradability based on 60% of theoretical oxygen demand (“ThOD”) or theoretical CO₂ evolution (“ThCO₂”). In another embodiment, readily biodegradability is determined by a non-respirometry method, OECD 301A or OECD 301E, having pass levels for ready biodegradability based on 70% removal of dissolved organic carbon (“DOC”). The pass values, for each of the above discuss test, must be reached in a 10-day window within the 28-day period of the test, except under certain circumstances. The 10-day window begins when the degree of biodegradation has reached 10% DOC, ThOD or ThCO2 and must end before day 28 of the test. Chemicals which reach the pass levels after the 28-day period are not deemed to be readily biodegradable.

In another such embodiment, readily biodegradability is measured by 60% of the theoretical oxygen demand.

The objects, features and advantages of the present invention are further illustrated by the following examples, but the particular materials and amounts thereof recited in these examples, as well as other conditions and details, should not be construed to unduly limit this invention. All materials are commercially available or known to those skilled in the art unless otherwise stated or apparent. All parts and percentages in the Examples and the Specification are by weight (based on 100% active material), unless otherwise specified.

### EXAMPLES

### Example 1

### General Procedure for the Synthesis of the Amides

From Amines and Fatty Acids

To a 5 Liter stainless steel reactor equipped with stirrer, thermometer, and manometer were charged the fatty acid (1 mol equivalent) and the amine (1.05 mol equivalents). The reactor was sealed and the reaction mixture stirred for 8 hours at 180° C. (During the reaction the pressure increased due to the formation of water). Water and unreacted amine were distilled from the reaction mixture at 180° C. and 5 mbar to give the desired amide.

From N,N-Dimethylamino Acid and Fatty Amines

To a 1 liter round bottom flask equipped with a stirrer, thermometer and distillation set-up were charged the fatty amine (1 mol equivalent) and the N,N-dimethylamino acid (1 mol equivalent). The mixture was heated to 200° C. and reaction water was distilled from the reaction mixture. After 4 hours at 200° C., residual water was removed by vacuum distillation to give the desired amide.

### Example 2

### General Procedure for the Synthesis of Amidoalkyl Quaternary Ammonium Methylsulfates

To a 1-L round bottom flask equipped with a stirrer, thermometer and reflux cooler were charged the amidoamine (1 mol equivalent) and a suitable solvent (typically iospropanol, butylglycol, water, or a mixture thereof). The solution was heated to 70° C. and dimethyl sulfate (0.97 mol equivalents) was added drop wise at a rate of 1 to 2 ml per minute, using a DOSIMAT set-up. Due to the exotherm the temperature of the reaction mixture typically increased to 75-80° C. After the addition, the reaction mixture was stirred for 2 hours at 80° C. to give the desired amidoalkyl quaternary ammonium methylsulfates.

### Example 3

### General Procedure for the Synthesis of Amidoalkyl Betaines

To a 1-L round bottom flask equipped with a stirrer, thermometer, and reflux cooler were charged the amidoamine (1 mol equivalent) and a suitable solvent (typically isopropanol, butylglycol, water or a mixture thereof). The solution was heated to 90° C. and sodium monochloroacetate (1.01 mol equivalents) was added in portions. After the addition, the reaction mixture was stirred for 3 hours at 90° C. to give the desired amidoalkyl betaine.

### Example 4

### General Procedure for the Synthesis of Amidoalkyl Quaternary Ammonium Methylsulfates in the Presence of the Nonionic Compound

To a 1-L round bottom flask equipped with a stirrer, thermometer and reflux cooler were charged the amidoamine (1 mol equivalent), the nonionic compound and a suitable solvent (typically water). The resulting solution or suspension was heated to 70° C. and dimethylsulfate (0.97 mol equivalents) was added dropwise at a rate of 1 to 2 mL per minute, using a DOSIMAT set-up. Due to the exotherm the temperature of the reaction mixture typically increased to 75-80° C. After the addition, the reaction mixture was stirred for 2 hours at 80° C. to give the desired amidoalkyl quaternary ammonium methylsulfates in the presence of the nonionic compound.

### Example 5

Several samples were evaluated for biodegradability based on the Closed Bottle Method (OECD 301 D). For the Closed Bottle Method, (a solution of) the test substance is put in a mineral medium and is inoculated with a relatively small number of micro-organisms from a mixed population and kept in completely full, closed bottles in the dark at constant temperature. Degradation is followed by analysis of dissolved oxygen over a 28-day period. The amount of oxygen taken up by the microbial population during biodegradation of the test substance, corrected for the uptake by a blank inoculum run in parallel, is expressed as a percentage of the theoretical oxygen demand (ThOD), calculated using the (determined) elemental composition of the test substance. Table 1 illustrates the results for biodegradability of alkylquats, etherquats, amiodoquats, and amphoteric compounds. Based on these results amidoalkyl quats (e.g. formula 1 and 2) and the amido amphoterics (e.g. formula 3 and 4) show relatively good biodegradability, generally sufficient to pass the European detergent guidelines.

TABLE 1

| | | | | % | |
|---|---|---|---|---|---|
| | | | | Biodegradation | |
| | | | | according to | Readily |
| Ex. # | Detergent Improver | Type | Composition | OECD 301D | Biodegradable¹ |
| C1 | RL 363/06 | Cationic | Ethoxylated coco fatty amine (2 moles EO), | | |
| | (Comparative) | | quaternized with DMS. | | |
| C2 | SERVO XB 68 | Cationic + PEG | Etherquat: Methyldiethanolamine quaternized | 17.2 | NO |
| | (Comparative) | 200 blend | with a C12 alcohol epichlorohydrin adduct. | | |
| C3 | SERVO NVA | Cationic | Coco fatty dimethylamine, HCl salt, | 4.1 | NO |
| | 1/40s | | quaternized with 1 mol EO. | | |
| | (Comparative) | | | | |
| I1 | RL 408/06 | Cationic | Amidoquat: Ethoxylated amide of coco fatty | | |
| | (Inventive) | | acid and aminoethylethanolamine, quaternized | | |
| | | | with DMS. | | |
| I2 | RL 449/06 | Cationic | Amidoquat: Amide of capric acid and | 88.9 | YES |
| | (Inventive) | | dimethylaminopropylamine, quaternized with | | |
| | | | DMS. | | |
| I3 | RL 482/06 | Cationic | Amidoquat: Amide of coco fatty acid and | | |
| | (Inventive) | | dimethyl-aminopropylamine, HCL salt, | | |
| | | | quaternized with 1 mol EO. | | |
| I4 | RL 483/06 | Cationic | Amidoquat: Amide of coco fatty acid and | | |
| | (Inventive) | | dimethylaminopropylamine, quaternized with | | |
| | | | DMS. | | |
| C4 | RL 443/06 | Cationic + PEG | Etherquat: Triethanolamine quaternized with a | | |
| | (Comparative) | 200 blend | C12 alcohol epichlorohydrin adduct. | | |
| C5 | Cyastat 609 | Cationic | Etherquat: Adduct of diethanolamine and a | 10.3 | NO |
| | (Comparative) | | C12-14 glycidyl ether, quaternized with DMS. | | |
| C6 | RL 509/06 | Cationic + PEG | Etherquat: Dimethylethanolamine quaternized | | |
| | (Comparative) | 200 blend | with a C12 alcohol epichlorohydrin adduct. | | |
| I5 | RL 506/06 | Amphoteric | Betaine: Amide of capric acid and dimethyl- | 82.1 | YES |
| | (Inventive) | | aminopropylamine, quaternized with | | |
| | | | chloroacetate | | |
| C7 | Amphitol 20 BS | Amphoteric | Betaine: Lauryldimethylamine, quaternized | | |
| | (Comparative) | | with chloroacetate. | | |
| I6 | RL 629/06 | Cationic | Amidoquat: Amide of isocarb 12 and | | |
| | (Inventive) | | dimethylaminopropylamine, quaternized with | | |
| | | | DMS. | | |
| I7 | RL 740/06 | Cationic | Amidoquat: Amide of 10-undecenoic acid and | | |
| | (Inventive) | | dimethylaminopropylamine, quaternized with | | |
| | | | DMS. | | |
| I8 | RL 743/06 | Cationic | Amidoquat: Amide of nonanoic acid and | | |
| | (Inventive) | | dimethylaminopropylamine, quaternized with | | |
| | | | DMS. | | |
| I9 | RL 767/06 | Cationic | Amidoquat: Amide of undecanoic acid and | | |
| | (Inventive) | | dimethylaminopropylamine, quaternized with | | |
| | | | DMS. | | |
| I10 | RL 825/06 | Cationic | Amidoquat: Amide of octanoic acid and | | |
| | (Inventive) | | dimethylaminopropylamine, quaternized with | | |
| | | | DMS. | | |
| I11 | RL 845/06 | Cationic | Amidoquat: Amide of dodecanoic acid and | 77.0 | YES |
| | (Inventive) | | dmithylaminopropylamine, quaternized with | | |
| | | | DMS. | | |
| C9 | SERVAMIN KW | Cationic | Ethoxylated coco fatty amine (15 moles EO), | | |
| | 100 | | quaternized with DMS. | | |
| | (Comparative) | | | | |

¹Minimum biodegradability was based on 60% of the theoretical oxygen demand.
DMS = Dimethylsulfate:
EO = Ethylene oxide.

Samples RL 449/06, RL 506/06, and RL 845/06 were readily biodegradable.

### Example 6

The samples of Table 1 were also tested for their cleaning ability, hydrotropicity, degreasing efficiency, wetting, foaming, surface tension, and rinse-off using the two detergent formulations of Tables 2 and 3.

TABLE 2
Formulation I

| | |
|---|---|
| 50 | Water (approx 50° C.) |
| 1 | Na-metasilicate |
| 5 | Tetra potassium pyrophosphate |
| 5 | Na-EDTA |
| 10 | Detergent improver |
| 5 | SERDOX NBS 6.6/90¹ |
| | NaOH (25%), qs to adjust pH to 10 |
| | Water, qs to adjust total to 100 |
| 100 | Total |

¹A nonionic surfactant available from Elementis Specialties

TABLE 3
Formulation II

| | |
|---|---|
| 60 | Water (approx 40° C.) |
| 5 | SERVO OT 200 |
| 3 | Detergent improver |
| 5 | Tetra potassium pyrophosphate |
| 5 | SERDOX NBS 6.6/90 |
| 2.5 | SERVO PPF 67² |
| 1 | 2-Butoxyethanol |
| | NaOH (25%), qs to adjust pH to |
| | 10 |
| | Water, qs to adjust total to 100 |
| 100 | Total |

²A nonionic surfactant available from Elementis Specialties

Methods:

Hydrotropicity Method CHL18

This method is used to determine the hydrotropic efficiency. It is based on the principle that a hydrotrope will elevate the cloud point of a non-ionic in alkaline solution. By using a known weight of alkaline hydrotrope and non-ionic the efficiency of the hydrotrope can be measured by the elevation of temperature to the cloud point where the non-ionic becomes insoluble. The non-ionic is a nonylphenol ethoxylate with a cloud point between 53-57° C.

187 grams of 6.28% sodium hydroxide solution were mixed with 8 grams of nonylphenol ethoxylate and 5 grams of the hydrotrope in a beakerglass. The mixture was mixed and warmed till 10° C. above the expected cloud point. Then the mixture was slowly cooled. The temperature at which the mixture changed from turbid to a clear solution was taken as the cloud point of the mixture.

Degreasing Tests

A film of grease (100 mg) was spread out on a glass plate to cover an area of approximately a 2 Euro coin. Approximately 6 mL total of the formulation was sprayed in 3 applications on the grease surface, without touching the surface. The glass plate was left in a vertical position for 5 minutes, rinsed with warm tap water (40° C.) for 10 seconds and judged on the amount of grease that was left on the surface. Both formulations I and II above were tested.

The degreasing efficiency was measured in % of grease that was washed off.

Wetting Tests

Wetting tests were performed according to the Draves Test method immersing a round cotton piece in the surfactant solution (0.05% aqueous solution of Formulation I or II). Time was measured until the cotton piece sinks to the bottom.

Foaming Tests

Foaming tests are done according to the Ross and Miles test method (ASTM D 1173).

Surface Tension

Surface tension measurements were carried out at a constant temperature of approx. 20° C. (Tamson water bath) using a Dataphysics DCAT 21 tensiometer. Surface tension was measured using 0.05% and 0.10% aqueous solutions of both Formulations I and II.

Practical Test—Rinse-Off Effect

A concentrated formulation was applied on a coated substrate. The formulations were dried for 3 minutes at the air and the substrates were rinsed off using normal water supply pressure. The treated surface of the substrates were judged visually on the rinse off effect and classified either bad (−) or good (+).

Table 4 summarizes the test results for wetting, foaming and surface tension. Table 5 summarizes the test results for hydrotropic efficiency, degreasing and the practical rinse off test.

TABLE 4

| | | | FOAMING (mm) | | | | Surface tension (mN/m) | | | |
|---|---|---|---|---|---|---|---|---|---|---|
| | WETTING (s) | | Formulation I | | Formulation II | | Formulation I | | Formulation II | |
| Product | Formulation I | Formulation II | Direct | 5 min. | Direct | 5 min. | 0.5% | 0.10% | 0.05% | 0.1% |
| C1 | 300 | 115 | 330 | 320 | 200 | 170 | 28.7 | 29.6 | 27.3 | 27.3 |
| C2 | 300 | 109 | 230 | 220 | 140 | 110 | 28 | 28.8 | 16.8 | 27.3 |
| C3 | 300 | 81 | 280 | 260 | 190 | 170 | 27.2 | 29 | 27 | 26.8 |
| I1 | 211 | 91 | 210 | 200 | 150 | 130 | 26.5 | 26.9 | 27.2 | 27.2 |
| I2 | 186 | 86 | 320 | 280 | 370 | 350 | 28.9 | 28.6 | 27.4 | 27.3 |
| I3 | 315 | 102 | 380 | 360 | 400 | 370 | 28.2 | 29.4 | 26.7 | 27.1 |
| I4 | 260 | 101 | 390 | 360 | 410 | 380 | 29.1 | 30.2 | 26.8 | 26.9 |
| C4 | 279 | 85 | 90 | 80 | 290 | 270 | 26.8 | 26.9 | 27 | 27 |
| C5 | 300 | 98 | 220 | 210 | 170 | 150 | 28.7 | 28.6 | 26.8 | 26.6 |
| C6 | 326 | 89 | 300 | 340 | 130 | 110 | 28.1 | 28.8 | 27 | 27.1 |
| I5 | 192 | 95 | 430 | 270 | 540 | 530 | 27.3 | 28.5 | 27.5 | 27.9 |
| C7 | 127 | 91 | 300 | 420 | 570 | 560 | 28.2 | 26.7 | 27 | 27.6 |
| I6 | 188 | 105 | 300 | 210 | 370 | 350 | 29.4 | 28.7 | 27.9 | 28.3 |
| I7 | 238 | 103 | 310 | 290 | 370 | 350 | 27.9 | 29.1 | 27.6 | 28 |
| I8 | 270 | 101 | 270 | 260 | 410 | 390 | 29.1 | 28.9 | 27.6 | 27.7 |
| I9 | 272 | 107 | 350 | 340 | 380 | 360 | 27.4 | 28.9 | 27.5 | 27.8 |
| I10 | 262 | 129 | 270 | 250 | 440 | 430 | 28.7 | 28.7 | 27.7 | 28.2 |
| I11 | 274 | 167 | 360 | 340 | 410 | 400 | 27.1 | 29.4 | 26.6 | 27.3 |
| C9 | 270 | 125 | 330 | 220 | 380 | 370 | 31.7 | 31.4 | 29.7 | 29.7 |

TABLE 5

| | | | Degreasing | Degreasing | |
|---|---|---|---|---|---|
| | | Hydrotr. | Formulation I | Formulation II | |
| Product | | Test (° C.) | (% Removal) | (% Removal) | Practical test |
| C1 | RI 363/06 | 61.5 | 97 | 95 | + |
| C2 | SERVO XB 68 | 50.5 | 100 | 100 | + |
| C3 | SERVO NVA 1/40 | 90 | 95 | 97 | + |
| I1 | RL 408/06 | 39.5 | 95 | 97 | + |
| I2 | RL 449/06 | 90 | 100 | 100 | + |
| I3 | RL 482/06 | 54.5 | 95 | 65 | + |
| I4 | RL 483/06 | 66 | 95 | 65 | + |
| C4 | RL 443/06 | 44 | 95 | 95 | + |
| C5 | RL 510/06 | 43.5 | 95 | 95 | + |
| C6 | RL 509/06 | 43 | 95 | 100 | + |
| I5 | RL 506/06 | 51 | 100 | 65 | + |
| C7 | RL 501/06 | 36 | 100 | 97 | + |
| I6 | RL 629/06 | 48 | 100 | 100 | + |
| I7 | RL 740/06 | 87.5 | 100 | 100 | + |
| I8 | RL 743/06 | 90 | 100 | 100 | + |
| I9 | RL 767/06 | 78.5 | 100 | 100 | + |
| I10 | RL 825/06 | 79 | 97 | 97 | + |
| I11 | RL 845/06 | 71.5 | 100 | 100 | + |
| C9 | SERVAMINE | 53.5 | 50 | 50 | + |
| | KW100 | | | | |

From Tables 4 and 5 we can conclude
RL 449/06, RL 629/06, RL 740/06, RL 743/06, RL 767/06, and RL 845/06 perform overall the best with excellent performance in hydrotropicity, degreasing and good rinse off effect.
The best degreasing performance is with SERVO® XB 68, RL 449/06, RL 629/06, RL 740/06, RL 743/06, RL 767/06, and RL 845/06.
In Formulation II, SERVO® NVA 1/40, RL 449/06, RL 501/06, and RL 443/06 show the best wetting performance
The Formulation I overall showed less wetting performance. The best additives are RL 449/06, RL 408/06, and RL 501/06.
SERVO® XB 68, RL 510/06, and RL 443/06 exhibit reduced foaming, Increased foam levels result from RL 483/06, RL 482/06, and RL 506/06,
All tested compositions except SERVAMIN® KW 100 show excellent surface tension reducing power bringing the surface tension of the formulation to 27 mN/m.
All tested samples showed a good rinse off effect.

The present disclosure may be embodied in other specific forms without departing from the spirit or essential attributes of the invention. Accordingly, reference should be made to the appended claims, rather than the foregoing specification, as indicating the scope of the disclosure. Although the foregoing description is directed to the preferred embodiments of the disclosure, it is noted that other variations and modification will be apparent to those skilled in the art, and may be made without departing from the spirit or scope of the disclosure.

What is claimed:

1. A readily biodegradable cleaning composition comprising an amidoalkyl quaternary salt and a non-ionic surfactant, wherein said amidoalkyl quaternary salt has formula (1) or (2) 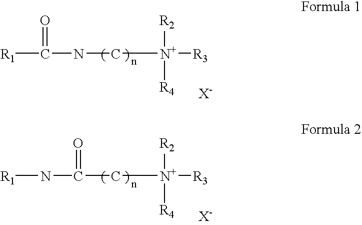
wherein R₁ includes a straight or branched chain alkyl radical, or straight or branched chain heteroalkyl radical, comprising from 8 to 20 carbon atoms, wherein said heteroalkyl radical includes an atom selected from the group consisting of: an oxygen atom, a nitrogen atom, a sulfur atom, and a phosphorus;
n ranges from 1 to 6;
R₂, R₃, and R₄ are independently selected from the group consisting of hydrogen, straight or branched chain alkyl radical or heteroalkyl radical, wherein said heteroalkyl radical includes an oxygen atom or a nitrogen atom, wherein said chains comprising 1 to 7 atoms, or polyalkoxy chain comprises 1 to 15 alkoxy units per chain, wherein said chains are optionally substituted; and
X⁻, wherein X⁻ is optionally a monovalent anion; or
wherein said amidoalkyl quaternary salt has formula (3) or (4) 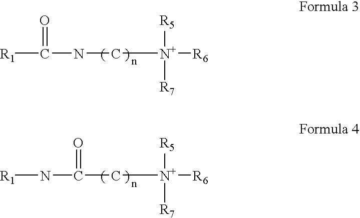
wherein R₁ includes a straight or branched chain alkyl radical, or straight or branched chain heteroalkyl radical, comprising from 8 to 20 carbon atoms, wherein said heteroalkyl radical includes an atom selected from the group consisting of: an oxygen atom, a nitrogen atom, a sulfur atom, and a phosphorus;
n ranges from 1 to 6;
wherein at least one of R₅, R₆ and R₇ includes a radical substituted with a carboxylic, sulfonic, phosphinic or phosphonic moiety, and the remainder are independently selected from the group consisting of hydrogen, straight or branched chain alkyl radical or heteroalkyl radical, wherein said chains comprising 1 to 7 atoms, or a polyalkoxy chain comprising 1 to 15 alkoxy units per chain, wherein said chains are optionally substituted.

2. The composition of claim 1, wherein for formulas (1) and (2), the amount of said monovalent anion X⁻ is sufficient to achieve electrical neutrality of the quaternary compound.

3. The composition of claim 1, wherein for formulas (1) and (2), said monovalent anion X⁻ includes chloride, bromide, methylsulfate, ethylsulfate, or acetate.

4. The composition of claim 1, wherein said optionally substituted chains have substituents including a alkoxy group (R—O—), acyloxy groups (R—C(═O)—O—), hydroxyl moieties (HO—), and a halide at any point along the chain.

5. The composition of claim 1, said polyalkoxy chain having 2 to 6 carbons per alkoxy unit.

6. The composition of claim 5, wherein said polyalkoxy chain comprises 1 to 4 alkoxy units per chain.

7. The composition of claim 5, wherein said polyalkoxy chain comprises 1 alkoxy units per chain.

8. The composition of claim 1, wherein R₁ comprises 8 to 12 carbon atoms.

9. The composition of claim 1, wherein n is 1.

10. The composition of claim 1, wherein n is 2.

11. The composition of claim 1, wherein n is 3.

12. The composition of claim 1, wherein the amidoalkyl quaternary salt having formula (3) or (4) forms an internal salt.

13. The composition of claim 1, wherein said quaternary salt has the formula of Formula 5, Formula 6, Formula 7, Formula 8, Formula 9, or Formula 10.

14. The composition of claim 1, wherein said non-ionic surfactant includes nonionic surfactants formed by condensation of alkyl phenols, alkyl amines, aliphatic alcohols or aliphatic acids with sufficient ethylene oxide, propylene oxide, or a combination thereof, to produce a compound having a polyoxyethylene and/or polyoxypropylene chain within the molecule, or a combination thereof.

15. The composition of claim 1, wherein said non-ionic surfactant is selected from the group consisting of a branched or linear primary alcohol ethoxylate, a secondary alcohol ethoxylate, a branched decyl/tridecyl alcohol ethoxylate, branched or linear, saturated or unsaturated fatty acid ethoxylates, a branched or linear alkylphenol ethoxylate, a branched or linear alkyl amine ethoxylate, an alkyl ether amine ethoxylate, a linear alcohol alkoxylate, and alkyl glucosides, and mixtures thereof.

16. The composition of claim 1, wherein said non-ionic surfactant is selected from the group consisting of a branched or linear primary alcohol ethoxylate/propoxylate, a secondary alcohol ethoxylate/propoxylate, a branched decyl/tridecyl alcohol ethoxylate/propoxylate, branched or linear, saturated or unsaturated fatty acid ethoxylate/propoxylate, a branched or linear alkylphenol ethoxylate/propoxylate, a branched or linear alkyl amine ethoxylate/propoxylate, an alkyl ether amine ethoxylate/propoxylate, a linear alcohol ethoxylate/propoxylate, and mixtures thereof, and wherein these ethoxylated/propoxylated derivatives may be either random or block copolymers, and the oxyethylene and oxypropylene units may be in any order.

17. The composition of claim 1, wherein the pH of said composition is greater than 7.0.

18. The composition of claim 1, wherein the pH of said composition is less than 5.0

19. The composition of claim 1, wherein the pH of said composition is in the range of 5.0 to 8.0.

20. The composition of claim 1 further comprising a thickening agent, a colorant, a fragrance, a preservative, an anti-microbial agent, a bacteriostat, a second surfactant, a chelating agent, an antioxidant, a foaming or anti-foaming agent, a film-forming agent, and combinations thereof.

21. The composition of claim 1, wherein said amidoalkyl quaternary salt having formulas (1)-(4) being readily biodegradable based on OECD protocol.

22. A method of cleaning a surface comprising contacting a surface with a composition of claim 1.

23. The method of claim 22, wherein said surface is substantially cleaned of food, industrial grease, heel marks, dirt, oils, traffic film, animal, and vegetable residues and combinations thereof.

24. The method of claim 22 wherein said surface includes a fibrous substrate and a hard surface.

25. The method of claim 24 wherein said fibrous substrate includes carpet and furniture.

26. The method of claim 24, wherein said hard surface includes tile, wood, metallic substances, coated metallic substances, plastics, glass and cement.

27. A process for the preparation of the composition of claim 1 comprising mixing the non-ionic surfactant and the amidoalkyl quaternary salt of Formula (1), Formula (2), Formula (3), or Formula (4).

28. A process for the preparation of the composition of claim 1 comprising preparing the amidoalkyl quaternary ammonium salt in the presence of the nonionic surfactant.
